(19) United States
(12) Patent Application Publication
(10) Pub. No.: US 2019/0210226 A1
(43) Pub. Date: Jul. 11, 2019

(54) ROBOT

(71) Applicant: University of Hertfordshire Higher Education Corporation, Hertfordshire (GB)

(72) Inventors: Kerstin Dautenhahn, Hertfordshire (GB); Ben Robins, Hertfordshire (GB); Luke Wood, Hertfordshire (GB)

(21) Appl. No.: 16/325,430

(22) PCT Filed: Aug. 16, 2017
(86) PCT No.: PCT/GB2017/052411

§ 371 Date: Feb. 14, 2019

(30) Foreign Application Priority Data
Aug. 17, 2016 (GB) 1614090.7

(51) Int. Cl. B25J 11/00; B25J 15/06

(52) U.S. Cl. CPC B25J 11/0005; B25J 13/085; B25J 15/0608

(57) ABSTRACT

This invention relates to a robot, more particularly to a child-sized expressive humanoid robot, with realistic, but simplified features, even more particularly to the hand of such a robot, where the hand comprises a magnet and an RFID sensor and optionally a FSR sensor to enable object interaction between a user and the robot.

### FIELD OF THE INVENTION

This invention relates to a robot, more particularly to a child-sized expressive humanoid robot with realistic, but simplified features, even more particularly to the hand of such a robot, where the hand comprises a magnet and an RFID sensor and optionally an FSR sensor to enable object interaction between a user and the robot.

### BACKGROUND OF THE INVENTION

KASPAR is a child-sized humanoid robot designed to help teachers and parents support children with autism. The robot was developed by the University of Hertfordshire's Adaptive Systems Research Group. KASPAR was designed for use as a social mediator, encouraging and helping children with autism to interact and communicate with adults and other children. KASPAR has the ability to engage in a range of interactive play scenarios, such as turn-taking or shared-gaze activities, which children with autism often find difficult to understand or perform. KASPAR's face is capable of showing a range of simplified expressions but with few of the complexities of a real human face. KASPAR has movable arms, head and eyes, which can be controlled by the teacher or parent but also can respond to the touch of a child. It is desirable to create a robot like KASPAR which is also capable of object interaction between a user and the robot.

Other humanoid robots that could be considered to perform a therapeutic role working in the field of children with autism include NAO and Milo. NAO is a small humanoid robot that is capable of performing gestures and similar to KASPAR. NAO however does not have a human like face and as a result cannot generate human like facial expressions in the same way that KASPAR can. Milo is a small humanoid robot similar to KASPAR, however it is not capable of tactile interaction due to the fragility of its joints and the lack of tactile sensors around the body.

### SUMMARY OF THE INVENTION

According to a first aspect of the invention there is provided a child-sized humanoid robot comprising a magnet and a Radio-Frequency Identification (RFID) sensor.

Preferably the robot further comprises a Force Sensing Resistor (FSR) sensor.

Preferably the robot comprises a hand wherein the hand comprises the magnet and the RFID sensor and the FSR sensor if provided.

Preferably the hand comprises a plastic core, in one alternative the hand comprises a 3D printed plastic core.

Preferably the plastic core is covered with a skin. The skin should be of a sufficient thickness not to break easily, preferably the skin is between about 2 mm and 3 mm thick. The skin thickness should be sufficient to provide good cover and protection, but not too thick so that it does not obstruct the sensory capacity of the components within the hand. In one alternative the skin is formed from a silicone in another alternative the skin is formed from a vinyl such as PVC.

In one alternative the magnet is a permanent magnet, in another alternative the magnet is an electromagnet. Preferably the magnet is embedded in the plastic core, preferably at the front of the plastic core, preferably where the palm of the hand is located.

Preferably the hand comprises a plurality of FSR sensors. Preferably the FSR sensor(s) are embedded in the front and rear of the plastic core. The FSR sensor(s) are preferably placed under the skin and can detect the approximate amount of pressure being exerted on them.

Preferably the RFID sensor is embedded in the plastic core, preferably at the front of the plastic core, preferably where the palm of the hand is located. Preferably the RFID sensor sits behind the FSR sensor in the plastic core

In an alternative the RFID sensor may be located in a separate platform rather than in the hand of the robot. In this alternative a platform is provided (which is connected to the robot) upon which objects comprising an RFID tag are to be place by the child, rather than placing them onto the hand of the robot. This would allow for larger objects to be utilised, such as items of crockery (plates, bowls, and cups), toy models of animals etc., wherein the child has to recognise the correct item to be located onto the platform.

According to a second aspect of the present invention there is provided an object comprising a magnet and an RFID tag.

In one alternative the magnet and RFID tag are detachably connected to the object, more preferably the magnet and RFID tag are located in a housing which is detachably connected to the object. In another alternative the magnet and RFID tag are embedded in the object.

According to a third aspect of the present invention there is provided an apparatus comprising a child-sized humanoid robot comprising a magnet and an RFID sensor and an object comprising a magnet and an RFID tag wherein when the object is brought into close proximity with the robot the object becomes removably attached to the robot and the RFID tag interacts with the RFID sensor.

Preferably the apparatus further comprises a FSR sensor.

Preferably when the RFID tag interacts with the RFID sensor the robot identifies the object.

Preferably when the robot identifies the object the robot provides the user with a response, the response in one alternative could be a verbal response, in another alternative the response could be a gestural response. Preferably the robot provides the user with both a verbal response and a gestural response. In a further alternative the response is a non-verbal sound such as a beep or a jingle.

Preferably the object is selected from; toothbrush, comb, hair brush, cloth, spoon, fork, cup, paintbrush, pencil, crayon, pair of glasses, microphone, food.

Preferably food is selected from; fruit, vegetable, cake, biscuit, chocolate.

Preferably the verbal response comprises the robot identifying the object.

Preferably where the object is food the verbal response in addition or in the alternative comprises the robot commenting on whether the robot likes the food with phrases such as “that is tasty” or “I don't like this”.

Preferably the gestural response comprises the robot simulating the typical action that the object would be used for.

In one alternative the object is a toothbrush, the verbal response comprises the robot identifying the object as a toothbrush and the gestural response comprises the robot simulating the action for brushing teeth with the toothbrush.

In one alternative the object is a comb the verbal response comprises the robot identifying the object as a comb and the gestural response comprises the robot simulating the action for brushing hair with the comb.

In one alternative the object is a hair brush, the verbal response comprises the robot identifying the object as a hair brush and the gestural response comprises the robot simulating the action for brushing hair with the hair brush.

In one alternative the object is a cloth, the verbal response comprises the robot identifying the object as a cloth and the gestural response comprises the robot simulating the action for washing the face of the robot with the cloth.

In one alternative the object is a spoon, the verbal response comprises the robot identifying the object as a spoon and the gestural response comprises the robot simulating the action for eating with the spoon.

In one alternative the object is a fork, the verbal response comprises the robot identifying the object as a fork and the gestural response comprises the robot simulating the action for eating with the fork.

In one alternative the object is a cup, the verbal response comprises the robot identifying the object as a cup and the gestural response comprises the robot simulating the action for drinking from the cup.

In one alternative the object is a paintbrush, the verbal response comprises the robot identifying the object as a paintbrush and the gestural response comprises the robot simulating the action for painting with the paintbrush.

In one alternative the object is a pencil, the verbal response comprises the robot identifying the object as a pencil and the gestural response comprises the robot simulating the action for writing with the pencil.

In one alternative the object is a crayon, the verbal response comprises the robot identifying the object as a crayon and the gestural response comprises the robot simulating the action for drawing with the crayon.

In one alternative the object is a pair of glasses, the verbal response comprises the robot identifying the object as a pair of glasses and the gestural response comprises the robot simulating the action for putting on the pair of glasses.

In one alternative the object is a microphone, the verbal response comprises the robot identifying the object as a microphone and the gestural response comprises the robot simulating the action for singing into the microphone.

In one alternative the object is food, the verbal response comprises the robot identifying the object as food and the gestural response comprises the robot simulating the action for eating the food. Preferably the verbal response comprises the robot identifying the object as the particular food that it is such as fruit, vegetable, cake, biscuit, chocolate. Preferably where the food is fruit or vegetable the verbal response comprises the robot identifying the object as the particular food that it is such as carrot, banana, apple, pear etc.

Preferably the Robot is configured to give a verbal response when the FSR sensor is activated above a predefined level.

Preferably the Robot is configured to give a response when the FSR sensor is activated above about 50% of the sensors maximum value from baseline for less than 2 seconds. Preferably the response is a verbal response and in one alternative comprises the phrase “please don't hit me”, or a phrase giving a similar impact on the user.

Preferably the Robot is configured to give a response when the FSR sensor is activated above about 90% of the sensors maximum value from baseline. Preferably the response is a verbal response and in one alternative comprises the phrase “that hurts”, or a phrase giving a similar impact on the user.

Preferably the Robot is configured to give a response when the FSR sensor is activated between about 80% and about 90% of the sensors maximum value from baseline. Preferably the response is a verbal response and in one alternative comprises the phrase “please don't be so rough with me”, or a phrase giving a similar impact on the user.

### BRIEF DESCRIPTION OF THE DRAWINGS

Other aspects and features of the present invention will become apparent to those ordinarily skilled in the art upon review of the following description of specific embodiments of the invention in conjunction with the accompanying figures.

FIG. 1 illustrates a wire from view of the palm of the core of the hand which the sensors and magnets are placed within;

FIG. 2 illustrates a view of the palm of the core of the hand illustrating the locations of the FSR sensor, RFID sensor and magnet;

FIG. 3 illustrates a view of the back of the core of the hand illustrating the locations of the FSR sensor, RFID sensor and magnet;

FIG. 4 illustrates a view of the base of the core of the hand illustrating the location of the RFID sensor;

FIG. 5 illustrates an FSR sensor used in the present invention;

FIG. 6 illustrates an RFID sensor used in the present invention;

FIGS. 7 and 8 illustrate views of the FSR sensor in situ in the hand;

FIGS. 9 and 10 illustrate views of the RFID sensor in situ in the hand;

FIG. 11 illustrates a view of the hand attached to the robot with the silicon skin applied over the core and accompanying components; and

FIGS. 12 to 14 illustrate the magnets being used to hold objects in the hand of the robot.

### DETAILED DESCRIPTION OF PREFERRED EMBODIMENTS

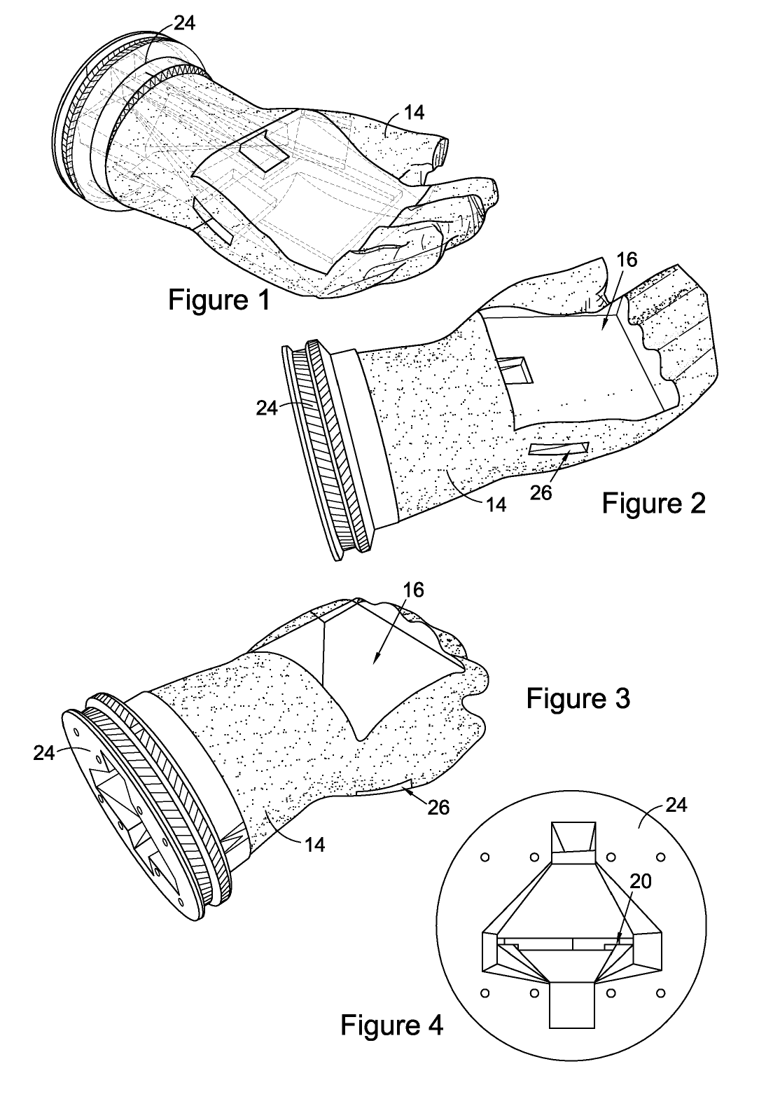

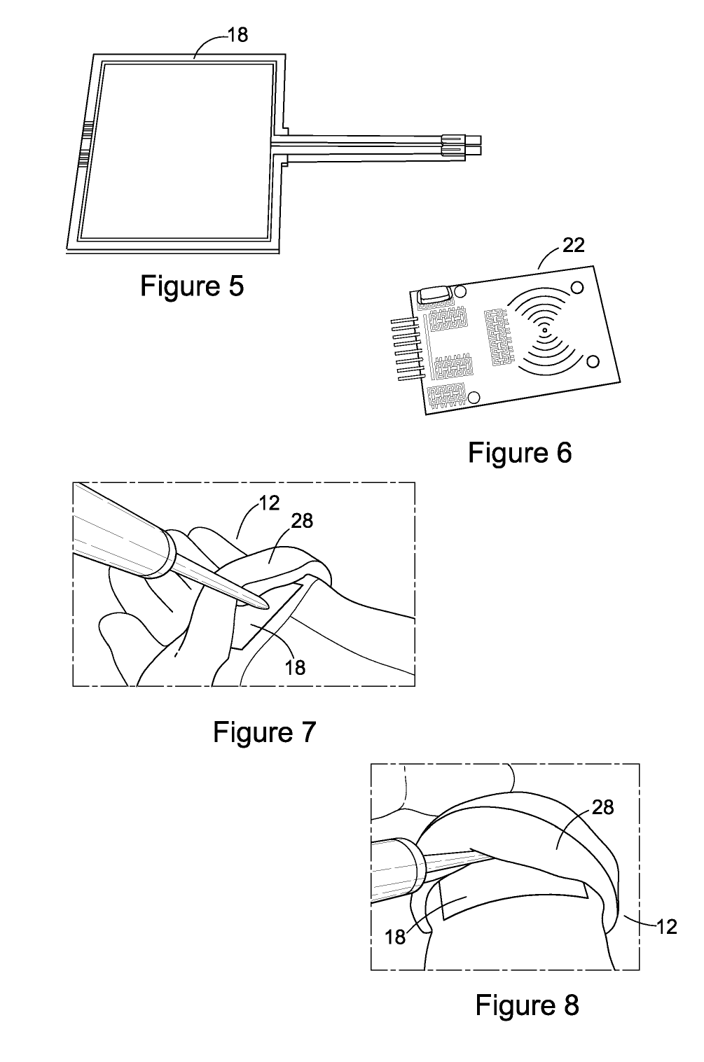

FIGS. 1 to 3 illustrate the core 14 of the hand 12 of the robot 10. The core 14 comprises an area 16 in which an FSR sensor 18 (shown in FIG. 5) is configured to be located in the form of a cut out section or recess, an area 20 in which an RFID sensor 22 (shown in FIG. 6) is configured to be located in the form of a cut out section or recess in the base 24, and an area 26 in which a magnet (not shown) is configured to be located in the form of a cut out section or recess. The core is in one alternative formed from a plastics material, such as: polylactic acid (PLA), polyethylene, polyvinyl, polypropylene, polystyrene, polyamides, acrylonitrile butadiene styrene (ABS) or polycarbonate. The core may be formed by injection moulding, or by 3D printing or by any other suitable manufacturing method. Recesses 16, 20, 26 are provided for installation of the FSR sensor 18, RFID sensor 22 and magnets so that the components sit substantially flush with the surface of the core 14, such that the components do not stick out.

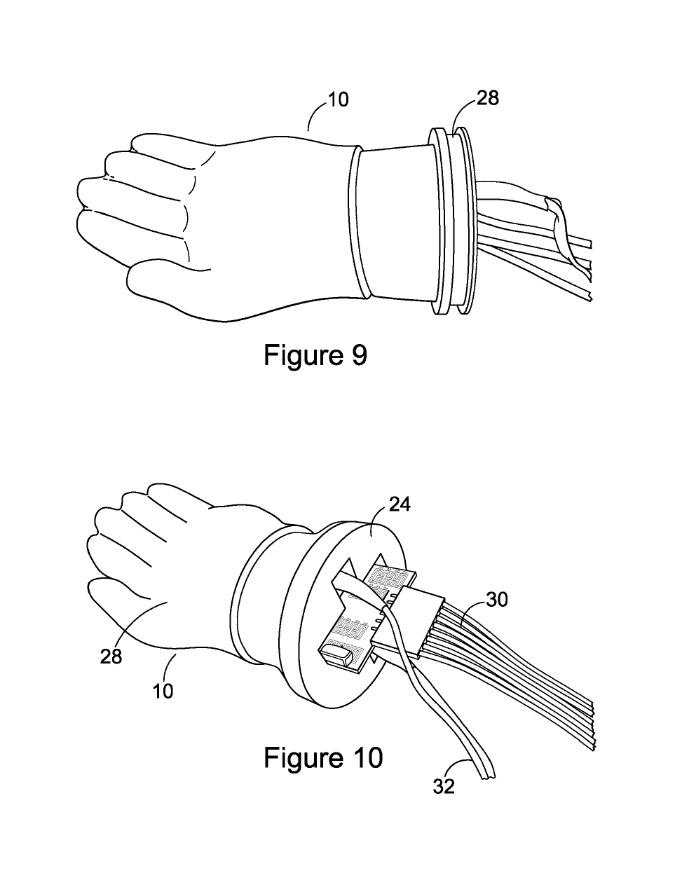

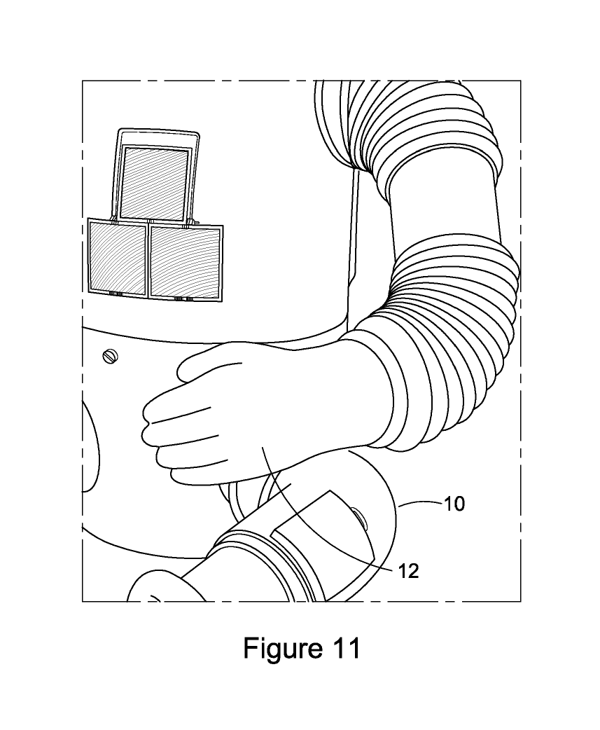

FIGS. 7 to 10 illustrate the hand 12 of the robot 10 with the skin 28 in situ over the core 14. In FIGS. 7 and 8 the skin 28 has been pealed back to reveal a portion of the core 14 and the FSR sensor 18 in situ in recess 16. In addition in FIGS. 9 and 10 electrical connectors 30, 32 are shown which connect the FSR sensor 18 and the RFID sensor to power and to the processing centre. When the magnets used are electromagnetic rather than permanent magnets, they would also be connecting via such electrical connectors to power and to the processing centre.

FIG. 11 illustrates the hand 12 of the robot 10 connected in situ to the robot 10.

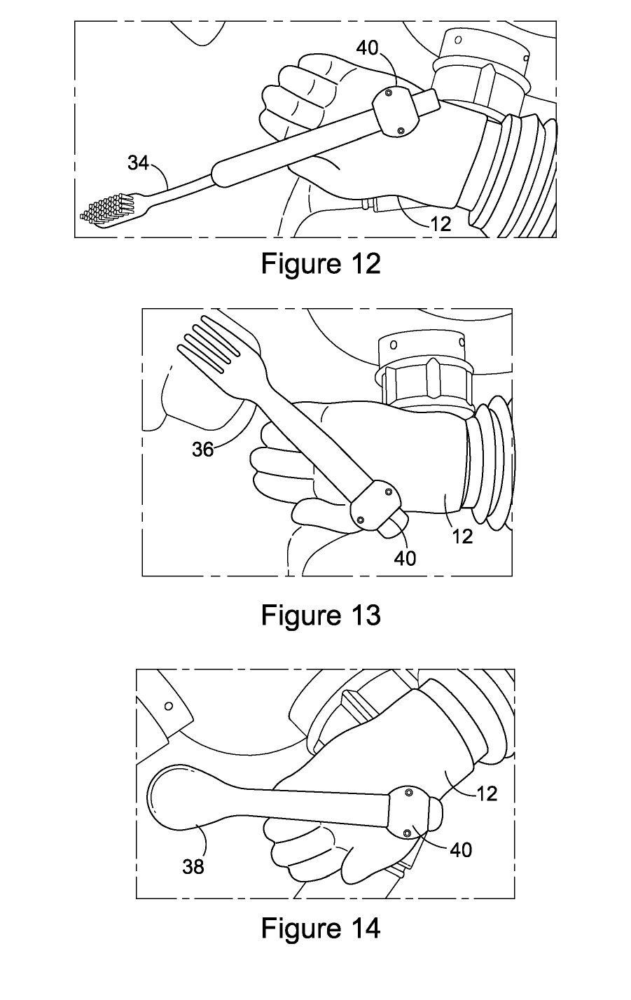

FIGS. 12 to 14 illustrate objects 34, 36, 38 that have been fitted with complimentary magnets and RFID tags in housing 40 which have been placed on the hand 12 of the robot 10. Preferably the housing 40 is detachably connected to the objects 34, 36 and 38 such that the housing 40 can be connected to any suitable object and removed again when not needed. Preferably the RFID tags are re-programmable and interchangeable within the housing 40 such that if the housing is detachably connect to a different object it can be programmed with that objects details.

In a typical situation, a child will be placed in close proximity to the robot 10 preferably with a supervising adult. The child will interact with the robot 10 through a number of scenarios which have been programmed into the robot 10. Such scenarios could either be automatically controlled or in the alternative controlled by the supervising adult through means of a control pad.

A typical scenario might include teaching the child to recognise the appropriate piece of cutlery for eating a particular food stuff. In this scenario, the robot 10 might be programmed to say that it is hungry and wants to eat some soup, and asks the child to give the robot 10 something to eat the soup with. The child might then be provided with a toothbrush 34, a spoon 38, and a fork 36. The child then would have to choose the appropriate object, which in this case would be the spoon 38 and give the spoon 38 to the robot 10. The corresponding magnets located in housing 40 allow the object to be held by the hand 12 of the robot 10, the RFID tag also located in housing 40 communicates with the RFID sensor 22 to allow the robot 10 to determine which object has been given to the robot 10, and the FSR sensor 18 determines how much pressure us being exerted on the hand 12 of the robot 10. The robot 10 will then process this information and verbally give feedback to the child. This might include saying “thank you the spoon would be perfect”, or that “the fork might not work as the soup will fall out of the gaps”, and “the toothbrush is for brushing teeth not for eating” and so on. If the object is given to the robot 10 with too much force, then the robot 10 might say “ow that hurt” or similar so that the child gets feedback that they have been too rough.

The Robot is configured to give a response when the FSR sensor is activated above a predefined level. The response may be a sound response such as a beep or a jingle or other sound, or in the alternative the response may be a verbal response.

The Robot is configured to give a response when the FSR sensor is activated above about 50% of the sensors maximum value from baseline for less than 2 seconds. Preferably the response is a verbal response and in one alternative comprises the phrase “please don't hit me”, or a phrase giving a similar impact on the user.

The Robot is configured to give a response when the FSR sensor is activated above about 90% of the sensors maximum value from baseline. Preferably the response is a verbal response and in one alternative comprises the phrase “that hurts”, or a phrase giving a similar impact on the user.

The Robot is configured to give a response when the FSR sensor is activated between about 80% and about 90% of the sensors maximum value from baseline. Preferably the response is a verbal response and in one alternative comprises the phrase “please don't be so rough with me”, or a phrase giving a similar impact on the user.

Below are examples of objects along with associated verbal and gestural responses associated therewith.

In one alternative the object is a toothbrush, the verbal response comprises the robot identifying the object as a toothbrush and the gestural response comprises the robot simulating the action for brushing teeth with the toothbrush.

In one alternative the object is a comb the verbal response comprises the robot identifying the object as a comb and the gestural response comprises the robot simulating the action for brushing hair with the comb.

In one alternative the object is a hair brush, the verbal response comprises the robot identifying the object as a hair brush and the gestural response comprises the robot simulating the action for brushing hair with the hair brush.

In one alternative the object is a cloth, the verbal response comprises the robot identifying the object as a cloth and the gestural response comprises the robot simulating the action for washing the face of the robot with the cloth.

In one alternative the object is a spoon, the verbal response comprises the robot identifying the object as a spoon and the gestural response comprises the robot simulating the action for eating with the spoon.

In one alternative the object is a fork, the verbal response comprises the robot identifying the object as a fork and the gestural response comprises the robot simulating the action for eating with the fork.

In one alternative the object is a cup, the verbal response comprises the robot identifying the object as a cup and the gestural response comprises the robot simulating the action for drinking from the cup.

In one alternative the object is a paintbrush, the verbal response comprises the robot identifying the object as a paintbrush and the gestural response comprises the robot simulating the action for painting with the paintbrush.

In one alternative the object is a pencil, the verbal response comprises the robot identifying the object as a pencil and the gestural response comprises the robot simulating the action for writing with the pencil.

In one alternative the object is a crayon, the verbal response comprises the robot identifying the object as a crayon and the gestural response comprises the robot simulating the action for drawing with the crayon.

In one alternative the object is a pair of glasses, the verbal response comprises the robot identifying the object as a pair of glasses and the gestural response comprises the robot simulating the action for putting on the pair of glasses.

In one alternative the object is a microphone, the verbal response comprises the robot identifying the object as a microphone and the gestural response comprises the robot simulating the action for singing into the microphone.

In one alternative the object is food, the verbal response comprises the robot identifying the object as food and the gestural response comprises the robot simulating the action for eating the food. Preferably the verbal response comprises the robot identifying the object as the particular food that it is such as fruit, vegetable, cake, biscuit, chocolate. Preferably where the food is fruit or vegetable the verbal response comprises the robot identifying the object as the particular food that it is such as carrot, banana, apple, pear etc. Preferably where the object is food the verbal response in addition or in the alternative comprises the robot commenting on whether the robot likes the food with phrases such as “that is tasty” or “I don't like this”.

1. A child-sized humanoid robot comprising a magnet and a Radio-Frequency Identification (RFID) sensor.

2. The child-sized humanoid robot as claimed in claim 1 further comprising a Force Sensing Resistor (FSR) sensor.

3. The child-sized humanoid robot as claimed in claim 1 comprising a hand, wherein the hand comprises the magnet and the RFID sensor.

4. The child-sized humanoid robot as claimed in claim 3 wherein the hand comprises a plastic core.

5. The child-sized humanoid robot as claimed in claim 4 wherein the plastic core is formed from one of the following materials: polylactic acid (PLA), polyethylene, polyvinyl, polypropylene, polystyrene, polyamides, acrylonitrile butadiene styrene (ABS) or polycarbonate.

6. The child-sized humanoid robot as claimed in claim 4 wherein the plastic core is covered with a skin.

7. The child-sized humanoid robot as claimed in claim 6 wherein the skin is between about 2 mm and 3 mm thick.

8. The child-sized humanoid robot as claimed in claim 6 wherein the skin is formed from silicone or PVC.

9. The child-sized humanoid robot as claimed in claim 1 wherein the magnet is a permanent magnet.

10. The child-sized humanoid robot as claimed in claim 1 wherein the magnet is an electromagnet.

11. An object comprising a magnet and an RFID tag.

12. The object as claimed in claim 11 wherein the magnet and/or the RFID tag is detachably connected to the object.

13. The object as claimed in claim 11 wherein the magnet and/or the RFID tag is embedded in the object.

14. An apparatus comprising a child-sized humanoid robot comprising a magnet and an RFID sensor and an object comprising a magnet and an RFID tag wherein, when the object is brought into close proximity with the robot, the object becomes removably attached to the robot and the RFID tag interacts with the RFID sensor.

15. An apparatus comprising a child-sized humanoid robot as claimed in claim 1 further comprising an FSR sensor.

16. The apparatus as claimed in claim 14 wherein, when the RFID tag interacts with the RFID sensor, the robot identifies the object.

17. The apparatus as claimed in claim 16 wherein, when the robot identifies the object, the robot provides the user with a response.

18. The child-sized humanoid robot as claimed in claim 2 comprising a hand, wherein the hand comprises the magnet, the RFID sensor, and the FSR sensor.

19. The child-sized humanoid robot as claimed in claim 18, wherein the hand comprises a plastic core.

20. The child-sized humanoid robot as claimed in claim 19 wherein the plastic core is covered with a skin.

21. The child-sized humanoid robot as claimed in claim 20 wherein the skin is between about 2 mm and 3 mm thick.

22. The child-sized humanoid robot as claimed in claim 20 wherein the skin is formed from silicone or PVC.

23. The apparatus as claimed in claim 15 wherein, when the RFID tag interacts with the RFID sensor, the robot identifies the object.

24. The apparatus as claimed in claim 23 wherein, when the robot identifies the object, the robot provides the user with a response.
